(19) United States
(12) Patent Application Publication
(10) Pub. No.: US 2017/0078844 A1
(43) Pub. Date: Mar. 16, 2017

(54) INFORMATION PROVIDING APPARATUS, INFORMATION PROVIDING METHOD, AND NON-TRANSITORY COMPUTER READABLE STORAGE MEDIUM

(71) Applicant: YAHOO JAPAN CORPORATION, Tokyo (JP)

(72) Inventor: Hiroshi OTA, Tokyo (JP)

(73) Assignee: YAHOO JAPAN CORPORATION, Tokyo (JP)

(21) Appl. No.: 15/224,912

(22) Filed: Aug. 1, 2016

(30) Foreign Application Priority Data
Sep. 14, 2015 (JP) 2015-180972

(51) Int. Cl. H04W 4/02; H04W 8/18; H04W 4/00; H04L 29/08

(52) U.S. Cl. CPC H04W 4/023; H04L 67/22; H04W 8/186; H04W 4/008; H04W 88/08

(57) ABSTRACT

An information providing apparatus according to an embodiment includes a specifying unit, a value determination unit, and an information providing unit. The specifying unit specifies a group of two or more users that behave together. The value determination unit determines value of the group specified by the specifying unit as an information provision destination. The information providing unit decides an information provision destination based on the value of the group determined by the value determination unit.

### CROSS-REFERENCE TO RELATED APPLICATION(S)

The present application claims priority to and incorporates by reference the entire contents of Japanese Patent Application No. 2015-180972 filed in Japan on Sep. 14, 2015.

### BACKGROUND OF THE INVENTION

1. Field of the Invention

The present invention relates to an information providing apparatus, an information providing method, and a non-transitory computer readable storage medium.

2. Description of the Related Art

In recent years, information provision using communication networks is popularly carried out along with the exponential spread of the communication networks. As a technology for the information provision, there is proposed a technology that provides information according to attributes of a group to which a plurality of persons belongs.

For example, there is proposed an apparatus that acquires attributes (genders and ages) of persons on the basis of an amount of characteristics of their face images that are captured by monitoring cameras or the like, determines attributes of the group, to which the persons belong, from attributes of each of them and the number of them, and provides information according to the determined group attributes (for example, see Japanese Laid-open Patent Publication No. 2004-227158).

However, the conventional apparatus only provides uniform information according to attributes of a group to which persons belong.

### SUMMARY OF THE INVENTION

It is an object of the present invention to at least partially solve the problems in the conventional technology.

An information providing apparatus according to an embodiment includes a specifying unit, a value determination unit, and an information providing unit. The specifying unit specifies a group of two or more users that behave together. The value determination unit determines value of the group specified by the specifying unit as an information provision destination. The information providing unit decides an information provision destination based on the value of the group determined by the value determination unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an information providing method according to an embodiment;

FIG. 2 is a diagram illustrating a configuration example of an information providing system according to the embodiment;

FIG. 3 is a diagram illustrating a configuration example of a wireless terminal;

FIG. 4 is a diagram illustrating a configuration example of an information providing apparatus;

FIG. 5 is a diagram illustrating an example of a user information table;

FIG. 6 is a diagram illustrating an example of a group value determination table;

FIG. 7 is a diagram illustrating an example of an acceptance degree determination table;

FIGS. 8 and 9 are diagrams illustrating examples of a display screen of the wireless terminal;

FIG. 10 is a flowchart illustrating an example of information processing in the information providing apparatus; and

FIG. 11 is a diagram illustrating a hardware configuration example of a computer that realizes functions of the information providing apparatus and the like.

### DETAILED DESCRIPTION OF THE PREFERRED EMBODIMENT

Hereinafter, an exemplary embodiment of an information providing apparatus, an information providing method, and a non-transitory computer readable storage medium according to the present application will be described in detail with reference to the accompanying drawings. It is not intended that the information providing apparatus, the information providing method, and the non-transitory computer readable storage medium according to this application be limited to the embodiment described below.

1. Information Providing Method

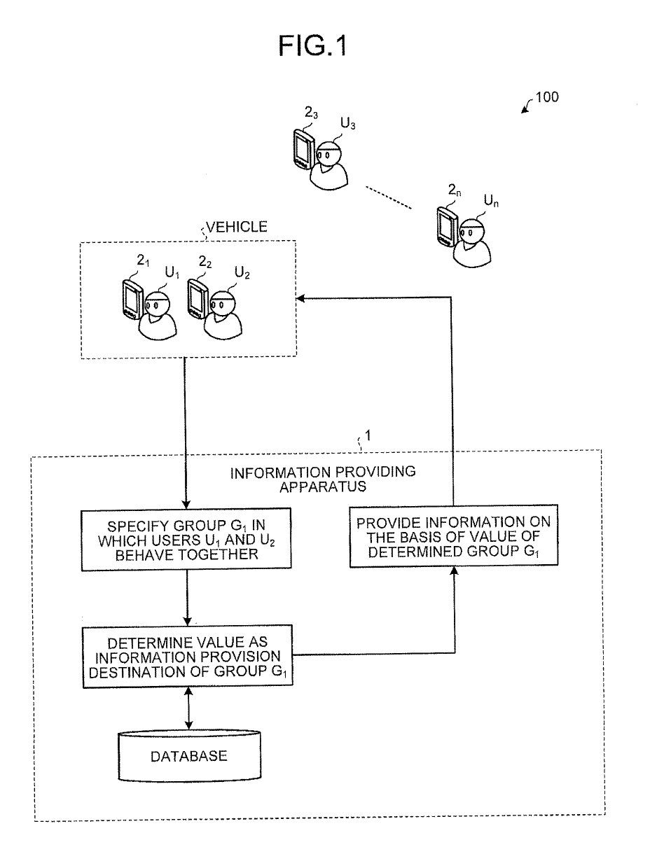

FIG. 1 is a diagram illustrating an example of an information providing method according to an embodiment. In the present embodiment, the information providing method is executed by an information providing apparatus 1 of an information providing system 100.

As illustrated in FIG. 1, the information providing system 100 includes, for example, the information providing apparatus 1 and wireless terminals 2₁ to 2ₙ that respective users U₁ to Uₙ have. Hereinafter, the users U₁ and U₂ are assumed to behave together.

The information providing apparatus 1 specifies the users U₁ and U₂ that behave together among users U₁ to Uₙ (hereinafter, may be collectively referred to as user(s) U). Whether the users behave together or not can be determined on the basis of, for example, information that is transmitted from the wireless terminals 2₁ to 2ₙ.

The wireless terminals 2₁ to 2ₙ (hereinafter, may be collectively referred to as wireless terminal(s) 2) include a wireless communication unit that performs Near Field Communication (NFC) such as Bluetooth®. Also, for example, infrared communication, visible light communication, sonic waves, or the like can be used as the NFC.

The information providing apparatus 1 can specify a group G₁ of the users U₁ and U₂ that behave together, on the basis of wireless signals that are received by the wireless terminals 2₁ to 2ₙ through the NFC. For example, when the wireless signals have been sent and received between the wireless terminals 2 for a predetermined time or more, the information providing apparatus 1 can specify a group of the users U that have the two or more wireless terminals 2, which have sent or received the wireless signals for a predetermined time or more, as a group in which the two or more users U behave together.

When specifying the group of the two or more users U that behave together, the information providing apparatus 1 acquires from a user information database or the like attribute information on the two or more users U that belong to the group. The attribute information on the users U is information on, for example, ages, genders, and interests and concerns of the users U.

The information providing apparatus 1 determines value (hereinafter, may be referred to as group value) of the specified group as an information delivery destination on the basis of the attribute information on the two or more users U that belong to the specified group. The group value is, for example, an index that indicates delivery effects of information, and further an index that indicates advertisement effects when the information is, for example, advertisement information.

The information providing apparatus 1 can determine the group value of a group that is specified in such a manner that, for example, the group value is higher as the number of persons that belong to the group is larger or the group value is higher as the matching degree to information to be provided is higher.

The information providing apparatus 1 provides information to any of the wireless terminals 2 of the two or more users U, which belong to the specified group, on the basis of the group value of the specified group. For example, the information providing apparatus 1 provides information, which includes a delivery charge set corresponding to the group value, to be able to deliver information with an appropriate delivery charge, and thus profit by the information provision can be improved.

The information providing apparatus 1 can determine, for each of the users U, an information acceptance degree that indicates a degree by which each of the two or more users U that belong to the specified group is able to accept information, and can provide information to the users U selected based on the information acceptance degrees and the group value.

Therefore, information delivery can be performed with a higher delivery charge, and thus the profit by the information provision can be improved. In this way, the information providing apparatus 1 can perform the information provision more appropriately. Hereinafter, the information provided by the information providing apparatus 1 may be referred to as contents.

2. Configuration of Information Providing System

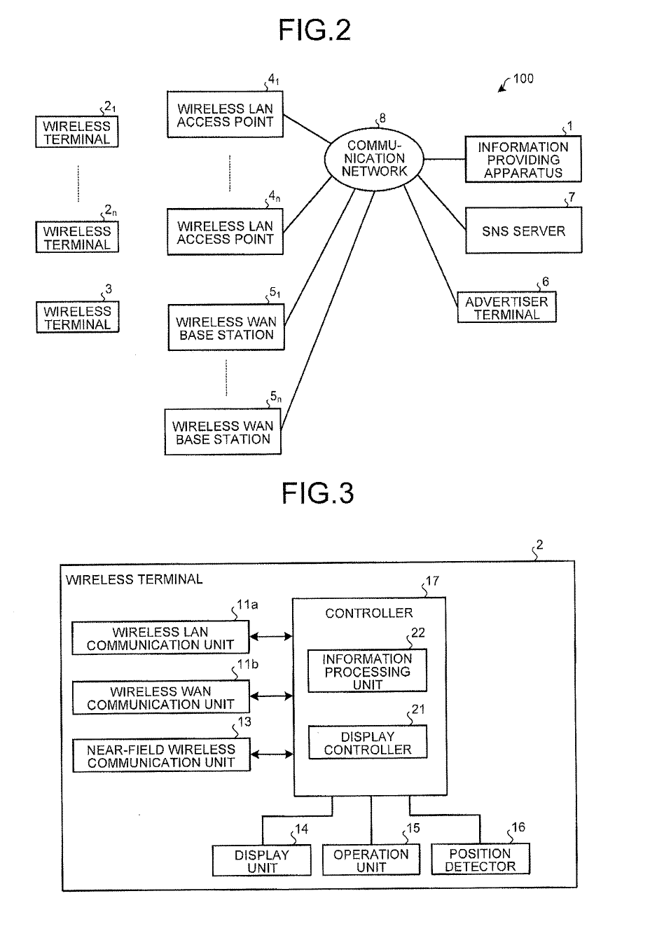

A configuration example of the information providing system 100 according to the embodiment will be explained with reference to FIG. 2. FIG. 2 is a diagram illustrating a configuration example of the information providing system 100 according to the embodiment.

As illustrated in FIG. 2, the information providing system 100 includes the information providing apparatus 1, the wireless terminals 2₁ to 2ₙ, a wireless terminal 3 (example of wireless communication unit), wireless Local Area Network access points (wireless LAN access points) 4₁ to 4ₙ (hereinafter, may be referred to as wireless LAN access point(s) 4), wireless Wide Area Network base stations (wireless WAN base stations) 5₁ to 5ₙ (hereinafter, may be referred to as wireless WAN base station(s) 5), an advertiser terminal 6, and a Social Networking Site server (SNS server) 7. The information providing apparatus 1, the wireless terminals 2, the wireless terminal 3, the advertiser terminal 6, and the SNS server 7 can communicate with each other through a communication network 8 that includes the wireless LAN access points 4 and the wireless WAN base stations 5.

The wireless terminals 2₁ to 2ₙ are wireless terminals that the respective users U₁ to Uₙ have. The wireless terminal 3 is a wireless device that is mounted on, for example, a train or a vehicle such as a taxi and a private automobile. The wireless terminals 2 and 3 are, for example, portable wireless terminals such as smartphones or tablets.

The information providing apparatus 1 can specify the group of the two or more users U that behave together on the basis of, for example, information that is sent from the wireless terminals 2₁ to 2, and the wireless terminal 3, and can determine the value of the group as an information delivery destination.

The information providing apparatus 1 can provide contents to the wireless terminals 2 of the users U or the wireless terminal 3 mounted on a vehicle in which the users U are getting on the basis of the value of the group as the information delivery destination.

Hereinafter, information provision processing that is performed by the information providing system 100 will be specifically explained around information processing by the wireless terminals 2 and the information providing apparatus 1. Hereinafter, the wireless terminals 2 and the information providing apparatus 1 will be explained in this order.

3. Wireless Terminal

FIG. 3 is a diagram illustrating a configuration example of the wireless terminal 2. As illustrated in FIG. 3, the wireless terminal 2 includes a wireless LAN communication unit 11a, a wireless WAN communication unit 11b, a near-field wireless communication unit 13, a display unit 14, an operation unit 15, a position detector 16, and a controller 17.

The wireless LAN communication unit 11a sends/receives wireless signals to/from the wireless LAN access points 4. The wireless LAN includes, for example, a wireless LAN defined by IEEE802.11 or the like, but is not limited thereto.

The wireless WAN communication unit lib sends/receives wireless signals to/from the wireless WAN base stations 5. The wireless WAN base stations 5 includes, for example, wireless base stations of public telephone communication networks and wireless base stations of public telephone data networks. Hereinafter, the wireless LAN communication unit 11a and the wireless WAN communication unit 11b may be collectively referred to as a communication unit 11.

The near-field wireless communication unit 13 sends or receives wireless signals via near-field wireless communication. The near-field wireless communication unit 13 is a NFC unit that employs a communication method such as, for example, Felica, ISO/IEC 14443 (MIFARE), Bluetooth®. The NFC may use, not limited to electrical waves, for example, infrared communication, visible light communication, sonic waves, or the like.

The display unit 14 is a touch panel type display. The user U of the wireless terminal 2 operates the top of a screen of the display unit 14 by fingers or the like to operate to the screen that is displayed at the display unit 14. The display unit 14 includes, for example, a compact Liquid Crystal Display (LCD) or an organic light emitting display.

The operation unit 15 includes a power button and a keyboard that includes keys for inputting letters, digits, and spaces, an enter key, arrow keys, or the like. The position detector 16 has a Global Positioning System receipt function (GPS receipt function) and acquires information on a present location and a moving speed of the wireless terminals 2. The information (hereinafter, may be referred to as location information) on the present location is information that indicates present latitude and longitude of the wireless terminals 2.

The controller 17 includes a display controller 21 and an information processing unit 22. The display controller 21 controls display contents of the display unit 14. For example, the display controller 21 can display a display screen on the display unit 14 on the basis of information acquired through the communication network 8 by the information processing unit 22 and display a display screen on the display unit 14 in accordance with input operations by the operation unit 15.

The information processing unit 22 acquires information from the information providing apparatus 1, the SNS server 7, a Web server (not illustrated), or the like through the communication unit 11. The information processing unit 22 can send information and requests to the information providing apparatus 1, the SNS server 7 and the Web server through the communication unit 11.

For example, the information processing unit 22 can inform, through the communication unit 11, the information providing apparatus 1 of information on wave intensity of wireless signals (hereinafter, may be referred to as received wireless signals) received by the near-field wireless communication unit 13 or identifiers included in the received wireless signals as terminal detection information.

The identifier included in the received wireless signal is, for example, a Media Access Control address (MAC address), an Universally Unique IDentifier (UUID), or the like, and may be referred to as a terminal ID hereinafter.

The information processing unit 22 can instruct the near-field wireless communication unit 13, for example, to send wireless signals periodically. The wireless signal includes information on the terminal ID that is different in each wireless terminal 2. The terminal ID is sometimes referred to as a beacon ID.

The information processing unit 22 can inform, through the communication unit 11, the information providing apparatus 1 of information on wave intensity of the received wireless signals and the terminal identifiers included in the received wireless signals as the terminal detection information. The terminal detection information includes the terminal ID (hereinafter, may be referred to as own terminal ID) that is included in the wireless signals that the information processing unit 22 makes the near-field wireless communication unit 13 output.

Also, the information processing unit 22 can inform, through the communication unit 11, the information providing apparatus 1 of information on, for example, the terminal ID (hereinafter, may be referred to as other terminal ID) as the terminal detection information, which is included in the wireless signal having been received by the near-field wireless communication unit 13 from another wireless terminal 2 for a predetermined time or more at wave intensity of a predetermined value or more.

The information processing unit 22 can acquire the location information from the position detector 16 to inform the information providing apparatus 1 of the location information from the communication unit 11.

Also, the wireless terminal 3 includes a near-field wireless communication unit similar to the near-field wireless communication unit 13 and sends wireless signals periodically. Similarly to the case of the controller 17 of the wireless terminal 2, a controller of the wireless terminal 3 can inform the information providing apparatus 1 of the terminal detection information when the near-field wireless communication unit receives a wireless signal sent from other wireless terminal 2. The terminal detection information includes, for example, the terminal identifiers (other terminal identifiers) of the wireless terminals 2, the terminal ID (own terminal ID) of the wireless terminal 3, and the wave intensity.

Also, the wireless terminal 3 can determine whether the user U of the wireless terminal 2 is a driver or a fellow passenger by, for example, being arranged in front of a driver's seat of a vehicle. For example, the user U of the wireless terminal 2 whose wave intensity is the highest of those of the received wireless signals can be determined as a driver, and the users U of other wireless terminals 2 can be determined as fellow passengers. The wireless terminal 3 may have a similar configuration as that of the wireless terminal 2.

4. Information Providing Apparatus

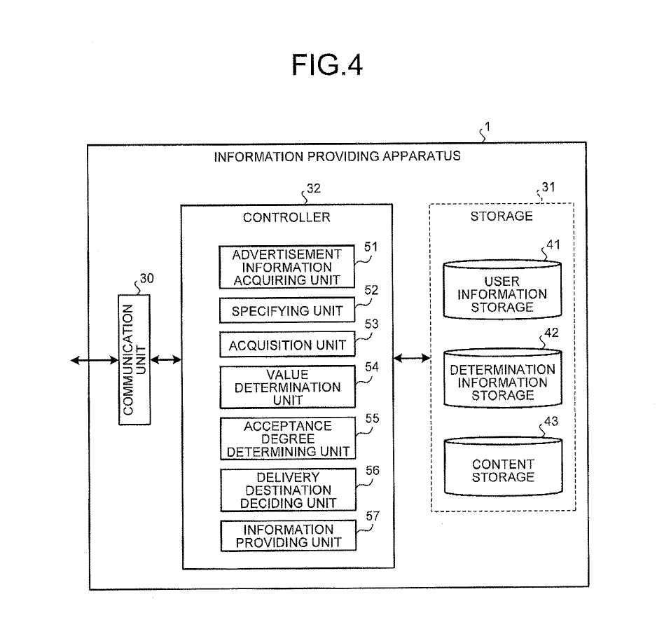

FIG. 4 is a diagram illustrating a configuration example of the information providing apparatus 1. As illustrated in FIG. 4, the information providing apparatus 1 includes a communication unit 30, a storage 31, and a controller 32.

4.1. Communication Unit

The communication unit 30 is an interface such as a Network Interface Card (NIC). The controller 32 sends/receives a variety of information to/from the wireless terminals 2 and 3 through the communication unit 30 and the communication network 8.

4.2. Storage

The storage 31 is a storage device such as a hard disk, a semiconductor memory device such as a Random Access Memory (RAM) or a flash memory, and an optical disk. The storage 31 includes a user information storage 41, a determination information storage 42, and a content storage 43.

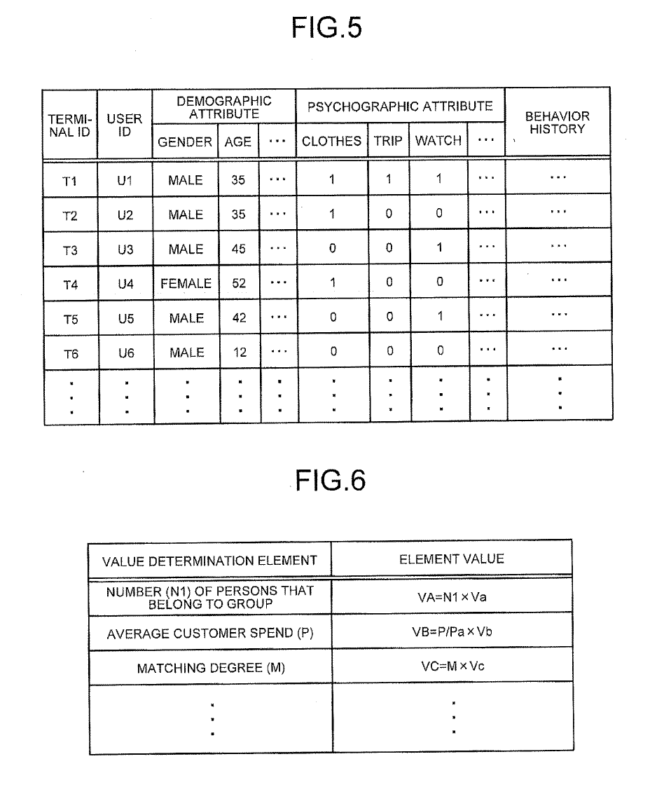

The user information storage 41 storages a user information table that includes, for example, information (hereinafter, may be referred to as attribute information) indicating the attributes of the users U. FIG. 5 is a diagram illustrating an example of the user information table. As illustrated in FIG. 5, the user information table includes information in which “terminal ID”, “user ID”, “demographic attribute”, “psychographic attribute”, and “behavior history” are associated with each other.

“Terminal ID” is a terminal ID of the wireless terminal 2. “User ID” is information on an identifier that identifies the user U. The terminal identifiers are expressed by “T1”, “T2”, etc., and, for example, the user identifiers of the users U₁ and U₂ are expressed by “U1” and “U2” in the user information table illustrated in FIG. 5 for convenience sake, however, this information is added to facilitate understanding, and is not limited thereto.

“Demographic attribute” indicates demographic attribute information on the user U. The “demographic attribute” falls into attribute sections such as “gender” and “age” of the user U. The “gender” is set to the gender of the user U. The “age” is set to the age of the user U. “Demographic attribute” may include, not limited to the example of attribute sections illustrated in FIG. 5, various attribute sections such as an occupation, a workplace, family structure, annual income, an address, a hometown, and educational background of the user U.

“Psychographic attribute” is information that indicates sense of values, lifestyles, character, tastes, or the like of the user U. The “psychographic attribute” falls into attribute sections such as “clothes”, “trip”, and “watch”. In an example illustrated in FIG. 5, “1” is set for each of the attribute sections when tastes of the user U are relatively high. “Psychographic attributes” may include, not limited to the example of attribute sections illustrated in FIG. 5, various attribute sections such as politics, economics, baseball, soccer, other sports, sweets, a personal computer, major appliances, and furniture.

“Behavior history” is information on a behavior history of the user U. Information on the behavior history of the user U is such as information on a purchase history of products or service of the user U, information on a participation history in an event of the user U, or information on a moving history of the user U.

The determination information storage 42 stores a group value determination table and an acceptance degree determination table or the like. First, the group value determination table will be explained. FIG. 6 is a diagram illustrating an example of the group value determination table.

As illustrated in FIG. 6, the group value determination table is information in which “value determination element” and “element value” are associated with each other. “Value determination element” is information that indicates elements that determine the group value. An example illustrated in FIG. 6 includes “number (N1) of persons that belong to group”, “average customer spend (P)”, “matching degree (M)”, or the like.

“Element value” is information that indicates value of the value determination element as an information provision destination. For example, value VA of the value determination element “number of persons that belong to group” can be obtained by multiplying the number N1 of persons that belong to group by a coefficient Va.

Value VB of the value determination element “average customer spend” can be obtained by dividing the average customer spend P by the standard average spend Pa, and multiplying the divided result by a coefficient Vb. Value VC of the value determination element “matching degree” can be obtained by multiplying the matching degree M by a coefficient Vc.

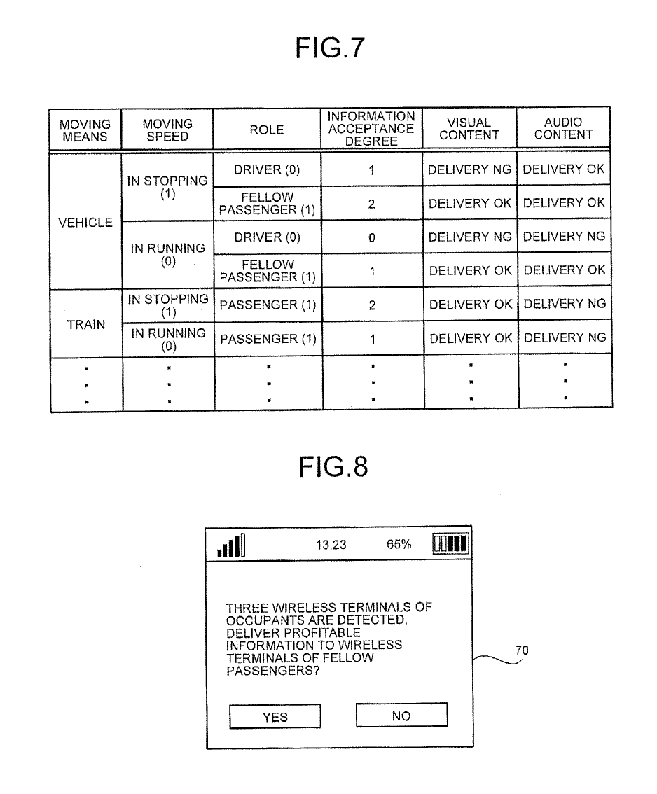

Next, the acceptance degree determination table will be explained. FIG. 7 is a diagram illustrating an example of the acceptance degree determination table. As illustrated in FIG. 7, the acceptance degree determination table is information in which “moving means”, “moving speed”, “role”, “acceptance degree”, “visual content” and “audio content” are associated with each other.

“Moving means” is information that indicates a moving means that is used for movement by a group of the two or more users U that behave together, and is, for example, a vehicle (automobile), a train, a ship, an airplane, walking, a bicycle, or the like. “Moving speed” is information that indicates a moving speed of a group of the two or more users U that behave together.

“Role” is information that indicates a role with respect to the moving means. For example, the role includes a driver and a fellow passenger in the case of a vehicle, and includes a passenger or the like in the case of a train. “Information acceptance degree” is information that indicates an acceptable degree of information of each of the two or more users U that belong to a group.

“Visual content” is content that the users U can visually comprehend, and “audio content” is content that the users U can acoustically comprehend. The controller 32 can use the acceptance degree determination table to determine to deliver the information acceptance degree, the visual contents, deliver the audio contents, or deliver the visual contents and the audio contents on the basis of combination of the moving means, the moving speed, and the role.

The content storage 43 stores information (hereinafter, may be referred to as link information) that indicates contents to be provided to the users U or storage positions of the contents. The contents to be provided to the users U include various contents such as, for example, news contents (including articles of magazines or the like), advertisement contents, and movie contents, and, for example, text data, static image data, moving image data, animation data, or the like are included as the contents data.

4.3. Controller

As illustrated in FIG. 4, the controller 32 includes an advertisement information acquiring unit 51, a specifying unit 52, an acquisition unit 53, a value determination unit 54, an acceptance degree determining unit 55, a delivery destination deciding unit 56, and an information providing unit 57.

For example, a Central Processing Unit (CPU), a Micro Processing Unit (MPU), or the like executes a program stored in a storage that is inside of the controller 32 using an inside RAM (not illustrated) as a workspace, and thus functions of the advertisement information acquiring unit 51, the specifying unit 52, the acquisition unit 53, the value determination unit 54, the acceptance degree determining unit 55, the delivery destination deciding unit 56 and the information providing unit 57 are executed.

4.3.1. Advertising Information Acquisition Unit

The advertisement information acquiring unit 51 can acquire a plurality of advertisement requests that include bid unit prices and advertisement contents from a plurality of advertisers. The advertisement request includes, for example, the advertisement content, the bid unit price, and information (hereinafter, may be referred to as target attribute information) that indicates an attribute that is an advertisement target.

The advertisement information acquiring unit 51 stores in the content storage 43 the advertisement content, the bid unit price, and the target attribute information, which are included in the advertisement request, with associating them with each other. For example, the advertisement information acquiring unit 51 can set in the content storage 43 the advertisement content, the bid unit price, and the target attribute information, which are included in the advertisement request, with associating them with each other.

The advertisement content may be data of the content itself, or may be link information that indicates a stored position of the advertisement content. Also, the advertisement request may include a movie content that includes the advertisement content (may be link information), or may be a news content that includes the advertisement content (may be link information). In other words, it is sufficient that the advertisement content is provided to the user U as a result.

4.3.2. Specifying Unit

The specifying unit 52 specifies a group (hereinafter, may be referred to group G) of the two or more users U that behave together on the basis of terminal detection information that is sent from the wireless terminals 2. For example, when receiving a wireless signal for a predetermined time or more at wave intensity of a predetermined value or more, the specifying unit 52 specifies the group G of the two or more users U that behave together on the basis of the wave intensity, the other terminal ID, and the own terminal ID included in the terminal detection information.

For example, when the users U₁ and U₂ are walking together, the wireless terminal 2₁ of the user U₁ continuously receives a wireless signal from the wireless terminal 2₂ of the user U₂, and thus wave intensity of the received wireless signal becomes a predetermined value or more. Similarly, the wireless terminal 2₂ continuously receives a wireless signal from the wireless terminal 2₁, and thus wave intensity of the received wireless signal becomes a predetermined value or more.

In this case, information on the own terminal ID “T1”, the other terminal ID “T2” and wave intensity is included in the terminal detection information from the wireless terminal 2₁, and information on the own terminal ID “T2”, the other terminal ID “T1”, and wave intensity is included in the terminal detection information from the wireless terminal 2₂. Therefore, the specifying unit 52 can specify the group G of the two or more users U₁ and U₂ that behave together on the basis of the terminal detection information on one of the wireless terminals 2₁ and 2₂ or the terminal detection information on the wireless terminals 2₁ and 2₂.

Also, as described above, when receiving the wireless signal for a predetermined time or more at wave intensity of a predetermined value or more, the wireless terminals 2 can inform the information providing apparatus 1 of the terminal detection information. In this case, the specifying unit 52 can specify the group G of the two or more users U that behave together on the basis of the own terminal ID and the other terminal ID that are included in the terminal detection information. For example, when the terminal detection information includes the own terminal ID “T2” and the other terminal ID “T1”, the specifying unit 52 can determine that the users U₁ and U₂ behave together.

In this way, when the wireless signal has been sent or received for a predetermined time or more between the wireless terminals 2 that the two or more users U have respectively, the specifying unit 52 can determine that the two or more users U behave together. Also, the specifying unit 52 takes account of the wave intensity, and thus the users U that behave together can be specified precisely.

The specifying unit 52 can specify the users U of the two or more wireless terminals 2 as the users U that behave together, which simultaneously receive the wireless signals from the same wireless terminal 3 for a predetermined time or more.

For example, it is assumed that the terminal detection information that is sent from the wireless terminal 2₁ includes the own terminal ID “T1” and the other terminal ID “Tx”, and the terminal detection information that is sent from the wireless terminal 2₂ includes the own terminal ID “T2” and the other terminal ID “Tx”. “Tx” is a terminal. ID of the wireless terminal 3. In this case, the specifying unit 52 can determine that the users U₁ and U₂ behave together.

Moreover, similarly to the wireless terminals 2, the wireless terminal 3 can send the terminal detection information. The terminal detection information includes all of the terminal identifiers of the wireless terminals 2, which receive wireless signals simultaneously, as the other terminal identifiers. In this case, the specifying unit 52 can specify the users U that behave together on the basis of the terminal detection information that is sent from the wireless terminal 3.

For example, it is assumed that the terminal detection information that is sent from the wireless terminal 3 includes the own terminal ID “Tx” and the other terminal identifiers “T1” and “T2”. In this case, the specifying unit 52 can determine that the users U1 and U2 behave together.

Moreover, when the wireless terminals 2 do not send the terminal detection information, the specifying unit 52 can specify the two or more users U that behave together on the basis of the location information that is sent from the wireless terminals 2. For example, when positions of the wireless terminals 2₁ and 2₂ are within a predetermined range for a predetermined time or more, the specifying unit 52 can determine that the users U₁ and U₂ behave together on the basis of the terminal detection information from the wireless terminals 2₁ and 2₂.

4.3.3. Acquisition Unit

The acquisition unit 53 acquires information on the two or more users U that belong to the group G specified by the specifying unit 52. For example, when the group G specified by the specifying unit 52 includes the users U₁ and U₂, the acquisition unit 53 acquires information on the users U₁ and U₂ of information on the users U, which is stored in the user information storage 41.

The acquisition unit 53 can acquire the moving histories of the users U from the SNS server 7, the wireless terminals 2, the wireless terminal 3, or the like connected to the communication network 8 to store it in the user information storage 41. The behavior histories of the users U includes, for example, information on the positions to which the users U move and date and time when the users U move, and also includes information on present positions of the users U.

For example, the acquisition unit 53 can store the moving histories of the users U based on the positions of the users U in the user information storage 41 on the basis of the location information that is sent from the wireless terminals 2. Positions to which the users U go and the time when the users U go can be determined by posting to the SNS server 7 of the users U, and they can be stored in the user information storage 41 as the behavior histories of the users U.

4.3.4. Value Determination Unit

The value determination unit 54 determines group value (hereinafter, may be referred to as group value V), which is value of the group G specified by the specifying unit 52, as the information provision destination. The group value V can be obtained with respect to, for example, each of the contents stored in the content storage 43.

The value determination unit 54 can determine the group value V as value determination elements on the basis of, for example, the number, the attributes, and the behavior histories of the users U included in the group G specified by the specifying unit 52, and the attributes and the behavior histories of the group G.

For example, the value determination unit 54 multiplies the number of the users N1, which are included in the group G, by the coefficient Va to obtain the value VA corresponding to the number of the users N1. Therefore, the group value V can be more enhanced, as the number of the users N1 included in the group G is larger.

The value determination unit 54 acquires the average customer spend P of the group G as the behavior history of the group G from the user information storage 41. The average customer spend P of the group G is amount per one of the users U of the group G spends, and differs for, for example, each store, product, or service, which is an advertisement target of a content to be provided.

The value determination unit 54, for example, divides the average customer spend P of the group G by the standard average spend Pa, and multiplies the divided result by the coefficient Vb to obtain value VB corresponding to the average customer spend P of the group G. Therefore, the group value V can be more enhanced, as the average customer spend P of the group G is higher.

The value determination unit 54 can multiply the matching degree M according to the group G by the coefficient Vc to obtain value VC according to the matching degree M. The matching degree M is a degree that indicates whether the attribute of the group G is adequate as the information provision destination, and the matching degree M differs according to the delivered information. Therefore, the group value V can be more enhanced, as the matching degree M of the group G is higher.

For example, in the users U that belong to the group G, when a lot of the users U favor “sushi” and no user U disfavors “sushi”, “sushi” is set to be favorable as attribute information of the group G. In the case of such a group G, because the value as an information provision destination is high for an advertisement content of “sushi restaurant”, the value determination unit 54 can raise the group value V.

The value determination unit 54 sums up values on the basis of each of the value determination elements, and can determine the summed-up result as the group value V. Therefore, the group value V can be determined on the basis of the number of the users U that are included in the group G specified by the specifying unit 52, the attributes of the group G, and the behavior history of the group G.

Moreover, when the attributes of the users U include an inappropriate attribute as the information provision destination, the value determination unit 54 can decrease the group value V. For example, even if an attribute that “sushi” is favorable is set as the attribute of the group G, the value determination unit 54 can decrease the group value V for an advertisement content of “sushi restaurant”, when at least one of the users U that belong to the group G has an attribute that “fish” is unfavorable.

The value determination unit 54 can also determine the group value V on the basis of the behavior histories of the users U. For example, when the proportion of the users U that do not go to a “sushi restaurant” lately to the users U that belong to the group G is high, the value determination unit 54 can increase the group value V for the advertisement content of “sushi restaurant”. On the contrary, when the proportion of the users U that go to a “sushi restaurant” lately to the users U that belong to the group G is high, the value determination unit 54 can decrease the group value V.

In this way, the value determination unit 54 can determine the group value V on the basis of a plurality of the value determination elements. However, the value determination unit 54 can also obtain the group value V on the basis of one or more selected value determination element within the plurality of the value determination elements without using all of the plurality of the value determination elements.

The value determination unit 54 can set as a value determination element an information acceptance degree that is the degree by which the users U that belong to the group G specified by the specifying unit 52 are able to accept information, and further determine the group value V on the basis of the information acceptance degree. The information acceptance degree can be determined by a method similar to the case of, for example, the information acceptance degree determined by the acceptance degree determining unit 55. The aforementioned determination of the group value V by the value determination unit 54 is an example, and not limited thereto.

4.3.5. Acceptance Degree Determining Unit

The acceptance degree determining unit 55 can determine the information acceptance degree that is the degree by which each of the two or more users U that belong to the group G specified by the specifying unit 52 is able to accept information.

The acceptance degree determining unit 55 can determine the information acceptance degree of each of the two or more users U that belong to the group G on the basis of, for example, at least one of the moving state and the role in the group G of each of the two or more users U that belong to the group G.

For example, the acceptance degree determining unit 55 can determine the information acceptance degree of each of the two or more users U that belong to the group G on the basis of the acceptance degree determination table. When the acceptance degree determination table is in such a state that is illustrated in FIG. 7, the value determination unit 54 can determine the information acceptance degree of each of the two or more users U that belong to the group G on the basis of the moving means, the moving speed and the role of the users U.

For example, when the moving means is “vehicle”, the moving speed is “in stopping”, and the role is “driver”, the acceptance degree determining unit 55 determines that the information acceptance degree is “1”. When the moving means is “vehicle”, the moving speed is “in stopping”, and the role is “fellow passenger”, the acceptance degree determining unit 55 determines that the information acceptance degree is “2”.

When the moving means is “vehicle”, the moving speed is “in running”, and the role is “driver”, the acceptance degree determining unit 55 determines the information acceptance degree is “0”. When the moving means is “vehicle”, the moving speed is “in running”, and the role is “fellow passenger”, the acceptance degree determining unit 55 determines that the information acceptance degree is “1”.

In this way, when the moving means is “vehicle”, because “driver” concentrates on driving, the possibility that the user U pays attention to comprehending provided information is low compared with that of “fellow passenger”. Therefore, the information acceptance degree of “driver” is lower than that of “fellow passenger”.

When the moving speed is “in running”, the possibility that the users U pay attention to comprehending provided information is lower than that of “in stopping”. Therefore, the information acceptance degree of “in stopping” is lower than that of “in running”.

When the moving means is “train”, the moving speed is “in stopping”, and the role is “passenger”, the acceptance degree determining unit 55 determines the information acceptance degree is “2”. The moving means is “train”, the moving speed is “in running”, and the role is “passenger”, the acceptance degree determining unit 55 determines the information acceptance degree is “1”.

The acceptance degree determining unit 55 can determine whether or not the moving means is “train” or “vehicle” on the basis of a moving route and speed of the user U. The acceptance degree determining unit 55 can determine whether or not the role is “driver” or “occupant” from information that is sent from the wireless terminal 3.

When a driver can be imaged by an on-vehicle device mounted on a vehicle, the acceptance degree determining unit 55 can also acquire an imaged image from the on-vehicle device, and specify the user U by image recognition on the basis of the user information stored in the user information storage 41. Also, when the on-vehicle device can identify the driver, the acceptance degree determining unit 55 can acquire an identification result of the user U by the on-vehicle device, and thus determine the driver.

In the aforementioned example, the acceptance degree determining unit 55 determines the information acceptance degrees of the users U on the basis of the moving means, the moving speed, and the roles of the users U, however, not limited thereto. For example, instead of or in addition to the moving means, the moving speed and the roles of the users U, when the users U operate the wireless terminals 2, the acceptance degree determining unit 55 can increase the information acceptance degree, and when the users U watches movie contents on the wireless terminals 2, the acceptance degree determining unit 55 can increase the information acceptance degree. Also in the aforementioned example, to facilitate the understanding, the information acceptance degree of the user U is explained to be three steps of 0, 1, and 2. However, the information acceptance degree may be more than 4 steps or 2 steps.

4.3.6. Delivery Destination Deciding Unit

The delivery destination deciding unit 56 can decide the user U (hereinafter, may be referred to as delivery target user) to be an information provision destination among the two or more users U that belong to the group G on the basis of the group value V determined by the value determination unit 54 and the information acceptance degree of each of the two or more users U that belong the group G.

The delivery destination deciding unit 56 can selectively execute a first mode and a second mode as a mode that decides a user U to be an information provision destination.

The delivery destination deciding unit 56 decides, in the first mode, the group G to be the information provision destination on the basis of the group value V, and then can decide the user U to be the information provision destination among the two or more the users U included in the decided group G on the basis of the information acceptance degrees of the users U.

The delivery destination deciding unit 56 can decide, in the second mode, the user U to be the information provision destination on the basis of the value (hereinafter, may be referred to as delivery score) of each of the users U as an information provision destination, which is determined on the basis of the group value V and the information acceptance degree of each of the two or more users U that belong to the group G. The delivery score is a score that indicates the value of the user U as the information provision destination.

It is here assumed that a group G1 of the users U₁ and U₂, and a group G2 of the users U₃ and U₄ are specified by the specifying unit 52, and the group value V of the group G1 is “12” and the group value V of the group G2 is “10”. It is also assumed that the information acceptance degrees of the users U₁ and U₃ are “1”, and the information acceptance degrees of the users U₂ and U₄ are “2”.

In this case, the delivery destination deciding unit 56 decides, in the first mode, the group G1 whose group value V is higher as the group G to be the information provision destination. Moreover, the delivery destination deciding unit 56 decides the user U₂ whose information acceptance degree is higher among the users U₁ and U₂ included in the group G1, which is set as the information provision destination, as a delivery target user of the highest priority, and sets the user U₁ as a delivery target user of a next priority order.

In this way, because the delivery destination deciding unit 56 can preferentially provide contents to the user U whose information acceptance degree is higher among the group G whose group value V is higher in the first mode, the contents can be provided effectively.

The delivery destination deciding unit 56, in the second mode, obtains a delivery score of each of the users U, which is determined on the basis of the group value V of the group G and the information acceptance degree of each of the two or more users U that belong to the group G. The delivery score of the user U1 is “12(=12×1)”, the delivery score of the user U2 is “24(=12×2)”, the delivery score of the user U3 is “10(=10×1)”, and the delivery score of the user U4 is “20 (=10×2)”.

Therefore, the delivery destination deciding unit 56 sets the user U₂ whose delivery score is the highest as a delivery target user of the highest priority, and further sets the user U₄ whose delivery score is the next highest as a delivery target user of a next priority order.

In this way, because the delivery destination deciding unit 56 can preferentially provide, in the second mode, contents to the user U whose delivery score based on the group value V and the information acceptance degree is high, the contents can be provided effectively.

The delivery destination deciding unit 56 can decide, by one of the first and second modes, an advertisement content to be delivered to the one or more users that belong to the group G out of a plurality of advertisement contents stored in the content storage 43 on the basis of the group value V, or the delivery score and the bid unit price.

For example, the delivery destination deciding unit 56 can preferentially assign, in the first mode, an advertisement content of high bid unit price to the group G of high group value V. Also, the delivery destination deciding unit 56 can preferentially assign, in the second mode, an advertisement content of the high bid unit price to the user U of the high delivery score.

The delivery destination deciding unit 56 can also decide, in the third mode, all of the users U that belong to a group of the highest group value V determined by the value determination unit 54 as delivery target users.

4.3.7. Information Providing Unit

The information providing unit 57 can preferentially send contents or link information of the contents from the communication unit 30 to the wireless terminal 2 of the delivery target user decided by the delivery destination deciding unit 56. When the wireless terminal 2 acquires the link information, the wireless terminal 2 acquires contents from the information providing apparatus 1 or a contents server on the basis of the link information via the communication network 8.

The information providing unit 57 can provide contents of a type corresponding to the delivery target user to the wireless terminal 2 of the user U. The type corresponding to the delivery target user is a type, for example, corresponding to a combination of the moving means, the moving speed and the role of the delivery target user.

For example, when the type according to a delivery target user is the moving means “vehicle”, the moving speed “in stopping” and the role “driver”, the information providing unit 57 delivers “audio content” and not “visual content” to the delivery target user on the basis of the acceptance degree determination table illustrated in FIG. 7.

When the type according to a delivery target user is the moving means “vehicle”, the moving speed “in stopping” and the role “fellow passenger”, the information providing unit 57 can deliver contents that meet one or both of “visual content” and “audio content” to the delivery target user.

In this way, because the type of contents according to the delivery target user can be provided to the wireless terminal 2 of the user U, the contents can be delivered appropriately to the user U.

When two or more users U that behave together are specified, the information providing unit 57 can send contents or link information of the contents to the wireless terminal 3 by the information providing unit 57 on the basis of the terminal ID of the wireless terminal 3.

For example, when the wireless terminal 3 is provided on a vehicle of a taxi, contents corresponding to the group value V can be displayed on the display units 14 of the wireless terminals 2 or a display unit of the wireless terminal 3 for the two or more users U that are in the taxi.

The information providing unit 57 determines, according to an action (for example, click or conversion) of the user U to an advertisement content by at least one user U to which the advertisement content is provided, advertising effects by the advertisement content. When a conversion occurs, the information providing unit 57 can update history of conversion to advertisement contents.

An example of information provision processing to the wireless terminals 2 by the information providing unit 57 will be here explained. It is assumed that the users U₁, U₂, and U₃ of the wireless terminals 2₁, 2₂, and 2₃ behave together and move by a vehicle, and the user U₁ is a driver. FIG. 8 is a diagram illustrating an example of a display screen displayed on the display unit 14 of the wireless terminal 2₁, and illustrates the display screen at the start of a navigation application. The navigation application is executed by the display controller 21 and the information processing unit 22.

In an example illustrated in FIG. 8, a message is displayed, which is “Three wireless terminals of occupants are detected. Deliver profitable information to wireless terminals of fellow passengers?”, to the display unit 14 of the wireless terminal 2₁ of the user U₁ that is a driver.

The information processing unit 22 of the wireless terminal 2₁ can detect the number of the wireless terminals 2 of the occupants (including driver) on the basis of wireless signals detected in the near-field wireless communication unit 13, and display the information illustrated in FIG. 8. Moreover, the information providing unit 57 may detect the number of the wireless terminals 2 of the occupants on the basis of the terminal detection information from the wireless terminals 2, and further send the information illustrated in FIG. 8 to the wireless terminal 2₁ of the driver.

Also, whether or not the wireless terminal 2₁ is the wireless terminal 2 of the driver can be specified by, for example, displaying a message on the display unit 14 before the display illustrated in FIG. 8, which is “Select ‘Yes’ being driver, select ‘No’ not being driver”. In such a case, when “Yes” is selected, the selected result is sent from the wireless terminal 2₁ to the information providing apparatus 1, and information, which indicates that the user U₁ of the wireless terminal 2₁ is the driver, is stored to the user information storage 41 of the information providing apparatus 1.

When the user U₁ operates the operation unit 15 or the display unit 14 of the wireless terminal 2₁ to select “Yes” in such a state that the screen illustrated in FIG. 8 is displayed, the selected result is sent from the wireless terminals 2₁, and the information provision processing by the information providing apparatus 1 is started.

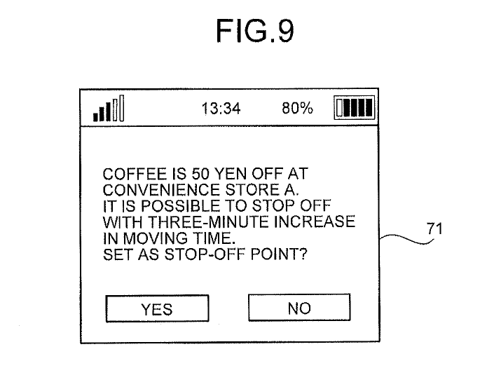

Then, the information is timely provided repeatedly to the wireless terminals 2₂ and 2₃ of the users U₂ and U₃, which are the fellow passengers, by the information providing unit 57 of the information providing apparatus 1. FIG. 9 is a diagram illustrating an example of information that is provided to the wireless terminals 2₂ and 2₃.

In an example illustrated in FIG. 9, a message, which is “Coffee is 50 yen off at convenience store A. It is possible to stop off with three-minute increase in moving time. Set as stop-off point?”, is displayed with respect to the display units 14 of the wireless terminals 2₂ and 2₃ of the users U₂ and U₃, which are the fellow passengers. Moreover, the group value V in this case includes, for example, moving routes, moving states, or the like of the users U₁, U₂, and U₃ in addition to the number of the occupants.

One of the users U₂ and U₃ operates the operation unit 15 or the display unit 14 of the own wireless terminal 2 to select “Yes” in such a state that the screen illustrated in FIG. 9 is displayed, the selected result is sent from the wireless terminal 2₁ to the information providing apparatus 1. The information providing unit 57 of the information providing apparatus 1 requests the wireless terminal 2₁ to set the convenience store A as a stop-off point, and the information processing unit 22 of the wireless terminal 2₁ sets the convenience store A as the stop-off point to navigate to the convenience store A.

In this way, because the information providing apparatus 1 and the wireless terminals 2 can provide information to the group G of the two or more users U that behave together according to the value of the group G as the information delivery destination, the information can be provided effectively to the users U. The example illustrated in FIG. 8 includes the screen that indicates whether or not the information is delivered to the wireless terminals 2 of the fellow passengers, however, the screen may indicate whether or not the information is delivered to the wireless terminals 2 of occupants including a driver.

5. Process Flow of Information Providing Apparatus

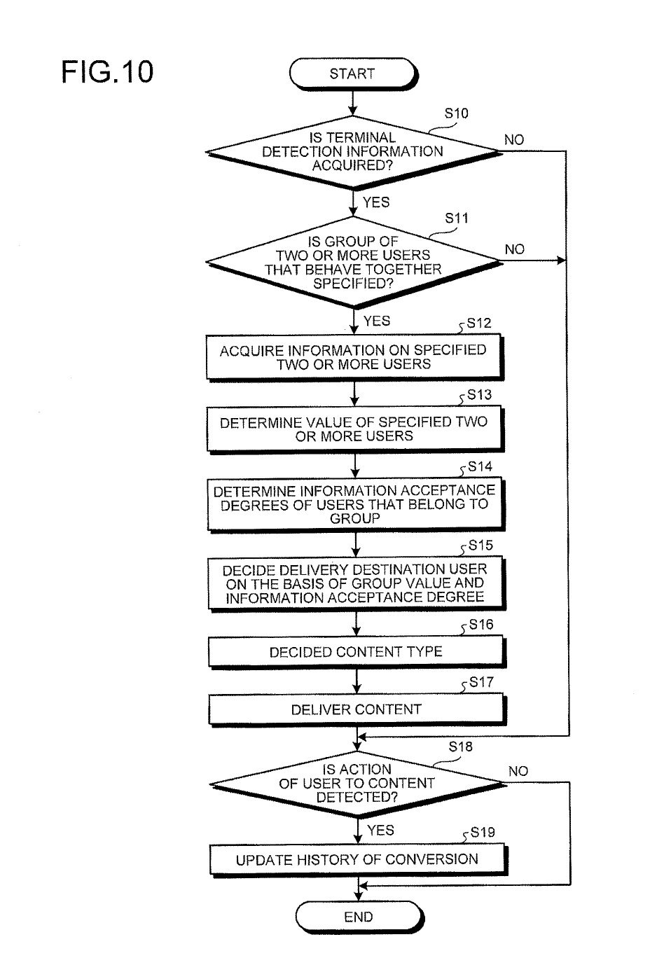

Next, a procedure of information provision processing by the information providing apparatus 1 according to the embodiment will be explained. FIG. 10 is a flowchart illustrating an example of information processing in the information providing apparatus 1.

As illustrated in FIG. 10, the controller 32 determines whether or not the terminal detection information is acquired from the wireless terminals 2 and/or the wireless terminal 3 through the communication unit 30 (Step S10). When the controller 32 determines that the terminal detection information is acquired (Step S10: Yes), the controller 32 determines whether or not the two or more users U is specified, which behave together, on the basis of the acquired terminal detection information (Step S11),

When the two or more users U are specified, which behave together (Step S11; Yes), the controller 32 acquires information on the specified two or more users U from the storage 31 (Step S12). Next, the controller 32 determines the value of a group of the specified two or more users U on the basis of the acquired information on the users U (Step S13). Also, the controller 32 determines the information acceptance degrees of the users U that belong to the specified group on the basis of the acquired information on the users U (Step S14).

The controller 32 decides the delivery destination user on the basis of the group value V and the information acceptance degrees of the users U that belong to the group G (Step S15). Also, the controller 32 decides a type of contents (for example, visual contents or audio contents) to be delivered to the delivery destination users (Step S16), and send contents of decided contents type to the wireless terminals 2 of the delivery destination users (Step S17).

When the process of Step S17 is completed, when the terminal detection information is not acquired in Step S10 (Step S10: No), or when the two or more users U that behave together are not specified in Step S11 (Step S11: No), the process is shifted to Step S18.

The controller 32 detects whether or not the user U performs an action to the provided contents in Step S18 (Step S18). When the controller 32 detects that the user U performs the action to the provided contents (Step S18: Yes), the controller 32 updates the history of conversion with respect to contents to which the action is performed (Step S19). When the process of Step S19 is completed, or when an action of the user U is not detected in Step S18 (Step S18: No), the controller 32 terminate the processes illustrated in FIG, 10.

6. Modified Example

The information on the wave intensity that is sent from the wireless terminal 2 may not be the value of the wave intensity itself, however, may be information on three steps of strong, middle, and weak of the wave intensity , for example. In this case, when the wave intensity of the wireless signals that one of the wireless terminals 21 and 22 receives is “strong”, or “middle”, the specifying unit 52 can determine that the users U1 and U2 behave together.

In the aforementioned embodiment, an example in which the wireless terminal 3 is mounted on the vehicle has been explained, however, the wireless terminal 3 can be provided in, for example, a commercial space such as a restaurant, a hotel, a hair salon/barber, a hospital, a theater, or a combined leisure facility. Moreover, the wireless terminal 3 also may be a digital signage.

In the aforementioned embodiment, the two or more users U are specified, which behave together, on the basis of the terminal detection information acquired from the wireless terminals 2 or the wireless terminal 3, or the location information acquired from the wireless terminals 2, however, not limited thereto. For example, the specifying unit 52 can specify two or more the users U that behave together on the basis of the positions of the wireless terminals 2 detected at the wireless LAN access point 4 or the wireless WAN base station 5.

Also, the specifying unit 52 specifies present positions of the users U by, for example, a positioning technology using geomagnetic data, and thus the two or more users U that behave together can be specified. For example, a geomagnetic sensor is provided in the position detector 16 of the wireless terminal 2, and a matching process between the geomagnetic data acquired by the geomagnetic sensor and a geomagnetic database previously stored in the position detector 16 is executed, and thus the position detector 16 can specify the present positions of the wireless terminals 2. The specifying unit 52 acquires from the wireless terminals 2 information that indicates the present positions of the wireless terminals 2 specified in this way, and thus, similarly to the case of the location information of the aforementioned GPS, the two or more users U that behave together can be determined on the basis of the information. The geomagnetic database may be stored in the storage 31 of the information providing apparatus 1, and the specifying unit 52 of the information providing apparatus 1 can acquire the geomagnetic data from the wireless terminals 2 to specify present positions of the wireless terminals 2 on the basis of the geomagnetic database.

In the aforementioned embodiment, an example in which the wireless terminal 3 is the portable wireless terminal such as a smartphone or a tablet, however, a wireless apparatus, instead of the wireless terminal 3, which has only function of periodically sending wireless signals through the NFC may be sufficient.

Also, in the aforementioned embodiment, the information on the users U is acquired from the user information storage 41 of the information providing apparatus 1, however, the information on the users U may be stored in the wireless terminals 2 and the information providing apparatus 1 may also acquire the information on the users U from the wireless terminals 2. Moreover, when the users U that behave together are increasing, the controller 32 can provide contents to the users U every time the users U increase by one or more.

The group value V is group value that is the value as an information provision destination of the group G, however, when the information to be provided includes advertisement contents, the group value V is an advertising effect index such as Click Through Rate (CTR), Cost Per Click (CPC), or effective Cost Per Mill (eCPM), or an index corresponding to the advertising effect index.

Also, the aforementioned value determination element may include, for example, the number of the users U that become the information provision destinations among the group G, the type of provided contents, a time zone, the positions of the users U, or the like. Therefore, the group value V can be determined more precisely.

For example, the value determination unit 54 can obtain value VD of the value determination element “number of informant” by multiplying the number of informants N2 by a coefficient Vd. Value VE of the value determination element “information provision” is obtained by multiplying information provision K by a coefficient Ve.

Also in the aforementioned embodiment, an example of “in stopping” and “in running” is explained as information on the moving speed. However, the moving speed may include, for example, “constant speed”, “in acceleration”, “in deceleration”, “constant speed”, or the like.

7. Hardware Configuration

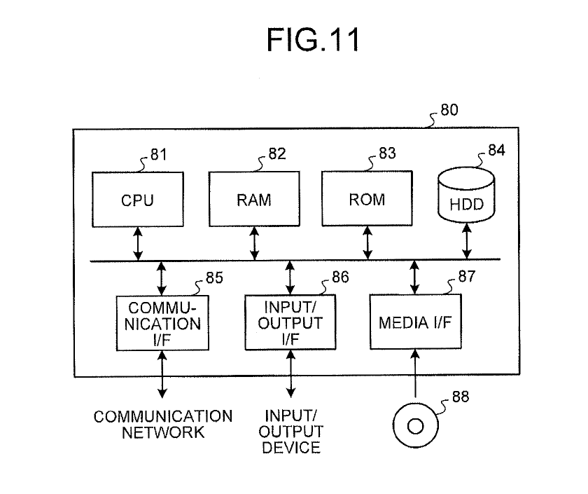

The information providing apparatus 1, the wireless terminals 2 and the wireless terminal 3 in the embodiment are realized by, for example, a computer 80 of a configuration illustrated in FIG. 11. FIG. 11 is a diagram illustrating a hardware configuration example of a computer that realizes functions of the information providing apparatus 1, the wireless terminals 2, and the wireless terminal 3. The computer 80 includes a Central Processing Unit (CPU) 81, a Random Access Memory (RAM) 82, a Read Only Memory (ROM) 83, a Hard Disk Drive (HDD) 84, a communication interface (I/F) 85, an input/output interface (I/F) 86, and a media interface (I/F) 87.

The CPU 81 operates on the basis of a program stored in the ROM 83 or HDD 84, and controls each unit. The ROM 83 stores a boot program that is executed by the CPU 81 at the start of the computer 80, programs that depend on hardware of the computer 80, or the like.

The HDD 84 stores programs that are executed by the CPU 81, data that are used by the programs, or the like. The communication interface 85, corresponding to the communication unit 11 or the communication unit 30, receives data from other devices through the communication network 8, sends the data to the CPU 81, and sends data generated by the CPU 81 to other devices through the communication network 8.

The CPU 81 controls an output device such as a display or a printer and an input device such as a keyboard or a mouse through the input/output interface 86. The CPU 81 acquires data from the input device through the input/output interface 86. The CPU 81 outputs generated data to the output device through the input/output interface 86.

The media interface 87 reads a program or data stored in a record medium 88, and provide them to the CPU 81 through the RAM 82, The CPU 81 loads the program from the record medium 88 onto the RAM 82 through the media interface 87, and executes the loaded program. The record medium 88 is an optical record medium such as a Digital Versatile Disc (DVD) or a Phase change rewritable Disk (PD), an optical magnetic record medium such as a Magneto-Optical disk (MO), a tape medium, a magnetic-record medium, a semiconductor memory, or the like.

When the computer 80 functions as the information providing apparatus 1, the CPU 81 of the computer 80 executes the program loaded on the RAM 82, and thus realizes each of the functions of the specifying unit 52, the acquisition unit 53, the value determination unit 54, the acceptance degree determining unit 55, the delivery destination deciding unit 56, the information providing unit 57 and the advertisement information acquiring unit 51. The HDD 84 realizes functions of the storage 31, and stores the value determination table and the acceptance degree determination table or the like.

When the computer 80 functions as the wireless terminals 2 and the wireless terminal 3, the CPU 81 of the computer 80 executes the program loaded on the RAM 82, and thus each of the functions of the display controller 21 and the information processing unit 22 is realized.

The CPU 81 of the computer 80 reads these programs from the record medium 88 to execute them, however, may acquire the programs from other devices through the communication network 8 as another example.

8. Effects

The information providing apparatus 1 according to the embodiment includes the specifying unit 52, the value determination unit 54, and the information providing unit 57. The specifying unit 52 specifies the group G of the two or more users U that behave together. The value determination unit 54 determines the group value V that is the value as an information provision destination of the group G specified by the specifying unit 52. The information providing unit 57 decides an information provision destination on the basis of the group value V determined by the value determination unit 54. Therefore, for example, the information providing apparatus 1 can provide information that includes a delivery charge set corresponding to the group value. As a result, information delivery can be executed with an appropriate delivery charge, and profit by information provision can be improved.

Also, the value determination unit 54 determines the group value V on the basis of at least one of the number, the attributes, and the behavior histories of the users U that is included in the group G specified by the specifying unit 52. In this way, because the group value V is determined on the basis of the users U included in the group G, the group value V can be determined precisely.

The value determination unit 54 determines the group value V on the basis of at least one of the attributes and the behavior histories of the group G specified by the specifying unit 52. Because the group value V is determined by using the group G totally as one determination index, the group value V can be determined precisely.

The value determination unit 54 determines the group value V on the basis of the degree by which the users U that belong to the group G specified by the specifying unit 52 are able to accept information. Therefore, the group value V including the information acceptance degree can be determined, and thus the group value V can be determined precisely.

The information providing apparatus 1 according to the embodiment includes the acceptance degree determining unit 55 and the delivery destination deciding unit 56. The acceptance degree determining unit 55 determines the information acceptance degree that indicates the degree by which each of the two or more users U included in the group G specified by the specifying unit 52 is able to accept information. The delivery destination deciding unit 56 decides the user U to be an information provision destination among the two or more users U that belong to the group G on the basis of the group value V and the information acceptance degree of each of the two or more users U that belong to the group G. The information providing unit 57 provides information to the user U decided as the information provision destination by the delivery destination deciding unit 56. In this way, because the information provision destination is decided on the basis of not only the value of the group G, but also the information acceptance degrees of the users U, contents can be provided effectively.

The delivery destination deciding unit 56 decides the group G to be the information provision destination on the basis of the group value V, and then decides the user U to be the information provision destination among the two or more users U included in the group G of the information provision destination on the basis of the information acceptance degrees of the users U that belong to the group G. Therefore, because the information is provided to the users U that belong to the group G whose group value V is high, contents can be provided effectively.

The delivery destination deciding unit 56 decides the user U to be an information provision destination among the two or more users U that belong to the group G on the basis of a delivery score determined based on the group value V and the information acceptance degree of each of the two or more users U that belong to the group G. The delivery score is value as an information provision destination of each of the two or more users U. Therefore, because information is provided to the users U whose group value V and information acceptance degree are high, contents can be provided effectively.

The acceptance degree determining unit 55 determines the information acceptance degree of each of the two or more users U that belong to the group G on the basis of at least one of a moving state and a role in the group G of each of the two or more users U that belong to the group G. In this way, because the information acceptance degree is determined on the basis of the moving states of the users U or the roles of the users U in the group G, the information acceptance degrees of the moving users U can be comprehended appropriately.

The information providing unit 57 provides to the user U information whose type is corresponding to the user U to be an information provision destination. Therefore, contents can be appropriately provided to the user U.

The specifying unit 52 specifies the two or more users U that behave together among the plurality of users U on the basis of wireless signals that are received by the wireless terminals 2 that the plurality of users U have respectively.

The specifying unit 52 determines that the two or more users U behave together when wireless signals are sent and received for a predetermined time or more between the wireless terminals 2 that the two or more users U have respectively. Therefore, for example, without providing separate equipment, the users U that behave together can be determined easily among the users U that have the wireless terminals 2.

When the wireless terminals 2 that the two or more users U have respectively are receiving wireless signals for a predetermined time or more from the same wireless terminal 3 (example of wireless communication unit), the specifying unit 52 determines that the two or more users U behave together. Therefore, for example, by providing the wireless terminal 3, the users U that behave together can be easily determined among the users U that have the wireless terminals 2.

The specifying unit 52 specifies the two or more users that behave together from the positions of the users U specified based on geomagnetic data detected by the wireless terminals 2 of the users U. Therefore, the positions of the users U can be detected precisely, for example, in a building or an underground place in which position detection by GPC is difficult.

The information providing apparatus 1 further includes the advertisement information acquiring unit 51. The advertisement information acquiring unit 51 acquires from a plurality of advertisers a plurality of advertisement requests including bid unit prices and advertisement contents. The information providing unit 57 decides an advertisement content to be delivered to at least one of the users U that belong to the group G among the plurality of advertisement contents included in the plurality of advertisement requests, on the basis of the group value V and the bid unit prices. Therefore, information, which includes the bid unit price set corresponding to the group value, can be provided, and thus profit by information provision can be improved.

9. Others

The configuration of the aforementioned information providing apparatus 1 may be changed flexibly. For example, the information providing apparatus 1 may be realized by a plurality of server computers, or, depending on functions, may be realized by calling an external platform or the like by using an Application Programming Interface (API) or network computing or the like. Moreover, arrows illustrated in FIGS. 1, 3, 4, etc. accessorily indicate the flows of data, controls, etc., and are not intended to deny other flows and to mean limitation of their directions.

According to one aspect of an embodiment, an information providing apparatus, an information providing method, and a non-transitory computer readable storage medium, which can provide information more appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing apparatus comprising:
a specifying unit that specifies a group of two or more users that behave together;
a value determination unit that determines value of the group specified by the specifying unit as an information provision destination; and
an information providing unit that decides an information provision destination based on the value of the group determined by the value determination unit.

2. The information providing apparatus according to claim 1, wherein the value determination unit determines the value of the group based on at least one of a number, attributes, and behavior histories of users that are included in the group specified by the specifying unit.

3. The information providing apparatus according to claim 1, wherein the value determination unit determines the value of the group based on at least one of an attribute and a behavior history of the group specified by the specifying unit.

4. The information providing apparatus according to claim 1, wherein the value determination unit determines the value of the group based on degrees by which the users included in the group specified by the specifying unit are able to accept information.

5. The information providing apparatus according to claim 1, further comprising:
an acceptance degree determining unit that determines an information acceptance degree that indicates a degree by which each of the two or more users included in the group specified by the specifying unit is able to accept information; and
a delivery destination deciding unit that decides a user to be the information provision destination among the two or more users based on the value of the group and the information acceptance degree of each of the two or more users, wherein
the information providing unit provides information to the user decided as the information provision destination by the delivery destination deciding unit.

6. The information providing apparatus according to claim 5, wherein the delivery destination deciding unit decides a group to be the information provision destination based on the value of the group, and then decides the user to be the information provision destination among the two or more users included in the decided group based on the information acceptance degrees.

7. The information providing apparatus according to claim 5, wherein the delivery destination deciding unit decides the user to be the information provision destination among the two or more users based on value as the information provision destination of each of the two or more users, which is determined based on the value of the group and the information acceptance degree of each of the two or more users.

8. The information providing apparatus according to claim 5, wherein the acceptance degree determining unit determines the information acceptance degree of each of the two or more users based on at least one of a moving state of each of the two or more users and a role of each of the two or more users in the group.

9. The information providing apparatus according to claim 1, wherein the information providing unit provides to the user a type of information that is corresponding to the user to be the information provision destination.

10. The information providing apparatus according to claim 1, wherein the specifying unit specifies the two or more users that behave together among a plurality of users based on wireless signals received by respective wireless terminals of the plurality of users.

11. The information providing apparatus according to claims 10, wherein the specifying unit determines that the two or more users behave together when the wireless signals are sent or received for a predetermined time or more between the respective wireless terminals of the two or more users.

12. The information providing apparatus according to claim 10, wherein the specifying unit determines that the two or more users behave together when the respective wireless terminals of the two or more users receive a wireless signal from a same wireless communication unit for a predetermined time or more.

13. The information providing apparatus according to claim 1, wherein the specifying unit specifies the two or more users that behave together from positions of the users, the positions being specified based on geomagnetic data detected by wireless terminals of the users.

14. The information providing apparatus according to claim 1, further comprising:
an advertisement information acquiring unit that acquires from a plurality of advertisers a plurality of advertisement requests that include bid unit prices and advertisement contents, wherein
the information providing unit decides an advertisement content to be delivered to one or more users included in the group among the advertisement contents included in the advertisement requests based on the value of the group and the bid unit prices.

15. A non-transitory computer readable storage medium having stored therein an information processing program, the program causing a computer to execute a process comprising:
specifying a group of two or more users that behave together;
determining value of the specified group as an information provision destination; and
deciding an information provision destination based on the determined value of the group.

16. An information providing method that is performed by a computer, the method comprising:
specifying a group of two or more users that behave together;
determining value of the specified group as an information provision destination; and
deciding an information provision destination based on the determined value of the group.
